(19) United States
(12) Patent Application Publication
(10) Pub. No.: US 2007/0157292 A1
(43) Pub. Date: Jul. 5, 2007

(54) SYSTEM, METHOD, AND COMPUTER-READABLE MEDIUM FOR JUST IN TIME ACCESS THROUGH DYNAMIC GROUP MEMBERSHIPS

(75) Inventors: Tim L. Danner, Houston, TX (US); David F. Perdue, Austin, TX (US); Patrick Lee McClendon, Sugarland, TX (US); Mark A. Lauritsen, Cypress, TX (US); Kevin Gross, Magnolia, TX (US); Kim S. Tor, Sugarland, TX (US)

Correspondence Address: HAYNES AND BOONE, LLP, 901 MAIN STREET, SUITE 3100, DALLAS, TX, 75202, US

(73) Assignee: NETIQ CORPORATION, San Jose, CA (US)

(21) Appl. No.: 11/465,144

(22) Filed: Aug. 17, 2006

Related U.S. Application Data
(60) Provisional application No. 60/755,146, filed on Jan. 3, 2006.

(51) Int. Cl. H04L 9/32; G06K 9/00; H04L 9/00; G06F 15/173; G06F 17/30; H04K 1/00; G06F 15/16; G06F 7/04; G06F 7/58; G06K 19/00

(52) U.S. Cl. 726/4; 726/5; 726/7; 726/6; 713/183; 709/225

(57) ABSTRACT

A system, method, and computer-readable medium for enabling a user account in a network system are provided.

### CROSS REFERENCE TO RELATED APPLICATIONS

This application claims priority to U.S. provisional patent application Ser. No. 60/775,146, attorney docket number 37894.5, entitled, SYSTEM, METHOD, AND COMPUTER-READABLE MEDIUM FOR GRANTING TIME-BASED PERMISSIONS AND JUST-IN-TIME ACCESS THROUGH DYNAMIC GROUP MEMBERSHIP, filed Feb. 21, 2006, by Danner, et al, the disclosure of which is incorporated herein by reference.

This application is related to U.S. utility patent application Ser. No. 11/420,125, attorney docket No. 37894.7, filed on May 24, 2006, the disclosure of which is incorporated herein by reference.

### BACKGROUND

Embodiments disclosed herein relate to, in general, network systems and, in particular, to operator permission mechanisms deployed in a network system.

### BRIEF DESCRIPTION OF THE DRAWINGS

Aspects of the present disclosure are best understood from the following detailed description when read with the accompanying figures, in which:

FIG. 1 is a diagrammatic representation of a network system in which embodiments disclosed herein may be implemented;

FIG. 2 is a diagrammatic representation of an exemplary computer system that may be configured for delegation of conditional time-based permissions and conditional permission authorizations in accordance with embodiments disclosed herein;

FIG. 3 is a diagrammatic representation of an embodiment of an exemplary computer system that may be configured as a client in a network system;

FIG. 4A is a diagrammatic representation of an embodiment of a change administrator server configuration that facilitates entitlement delegation and configuration in accordance with embodiments disclosed herein;

FIG. 4B is a diagrammatic representation of an embodiment of a operator console server software configuration that facilitates receipt, processing, and authorization of operator access requests;

FIG. 5 depicts a diagrammatic representation of a table in which entitlements implemented in accordance with embodiments disclosed herein may be maintained;

FIG. 6 is a diagrammatic illustration of an authentication directory in which proxy accounts may be created, enabled, and disabled according to conditional entitlements in accordance with embodiments disclosed herein;

FIG. 7 is a flowchart depicting processing steps of an authorization routine for authorizing explicit operator access requests in accordance with embodiments disclosed herein;

FIG. 8 is a flowchart of a schedule evaluation subroutine for evaluating an entitlement schedule in accordance with embodiments disclosed herein;

FIG. 9 is a flowchart depicting an embodiment of processing steps of a proxy account enablement routine that facilitates dynamic account enablement; and

FIG. 10 is a flowchart depicting an embodiment of processing steps of a proxy account disablement routine that facilitates disablement of dynamically enabled accounts.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Information Technology (IT) operators may require various permissions on servers to perform tasks in a network system. However, the same administrative permissions are not required at all times. In conventional practice, IT operators obtain or are otherwise assigned, at all times, a superset of all of the permissions they are likely to need at any time. This manner of access permission is often undesirably excessive. Moreover, conventional permission schemes implemented in a network environment are either granted or not granted. That is, an IT operator is either granted a permission or is not granted the permission. If an operator has a permission granted thereto, e.g., an access permission, an operational permission, or the like, the operator may perform any action(s) allowed by the permission until that permission is revoked. No concept of conditional permissions is provided in conventional administrative permission mechanisms. Assignment of operator permissions may be performed according to one of two general mechanisms. An administrator responsible for assignment of permissions may either grant permissions broadly or manually grant and revoke permissions when necessary. Neither option is ideal. Broad permissions lead to a lack of control, and manual permission granting is burdensome, error-prone, and time consuming.

In accordance with embodiments disclosed herein, an operator may be granted a conditional permission by an administrative manager or other authorized personnel having privilege granting rights assigned thereto. As referred to herein, a primary administrator is a network personnel authorized to grant entitlements to operators. As referred to herein, an operator is an administrator or other personnel that has entitlements granted thereto by the primary administrator. An entitlement, as referred to herein, defines an operational permission that may include a mapping of an operator to one or more network entities, such as a server, network infrastructure, or the like, associated operational privilege(s) allowed to be performed by the operator on the one or more network entities, and one or more schedules that define a time-basis on which the privileges are allowed to be performed on the associated network entities by the particular operator. When an operator requests access to a server with a certain set of privileges, an evaluation of the operator's privileges may be made. In the event that the operator has the requisite privileges, a proxy account may be enabled or created for the operator.

In accordance with an embodiment, a proxy account may be enabled consistent with a conditional entitlement allocated for an operator that has issued a request for access to a server, and the operator may be granted a remote session on the server with the proxy account in the event the operator has a privilege consistent with the request. The proxy account password may be reset, and the operator may be added to a user group of the server specified in the access request. A remote session may then be established between an operator console and the server specified in the access request. When a session ends or is otherwise terminated, the account may be disabled and the password of the account may be reset.

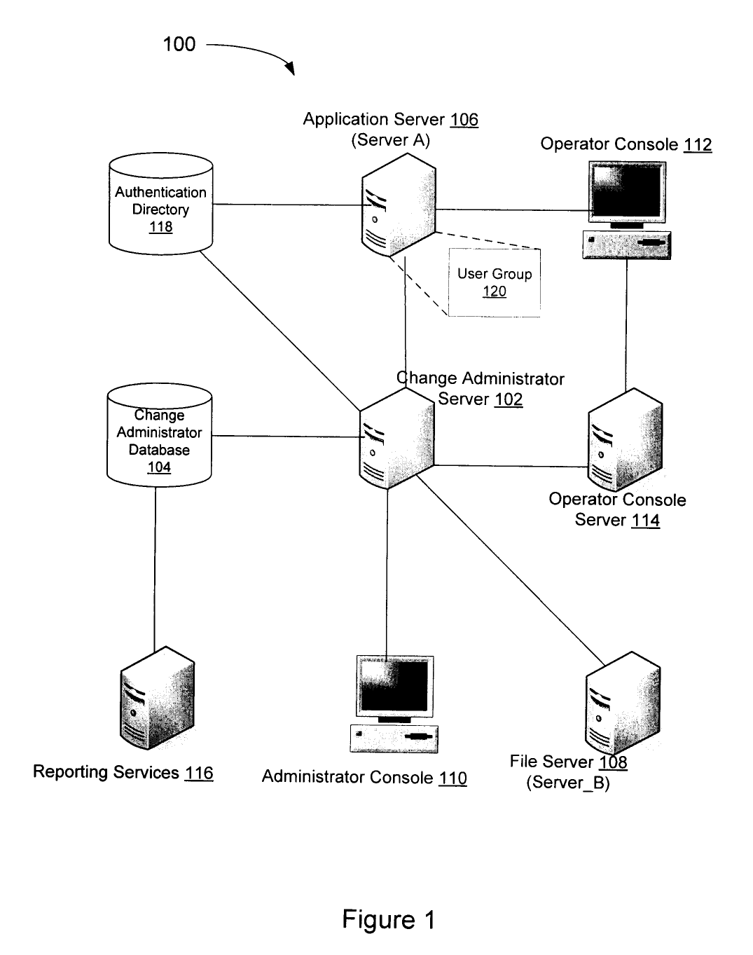

FIG. 1 is a diagrammatic representation of a network system 100 in which embodiments disclosed herein may be implemented. Network system 100 is a network of computers and requisite network infrastructure and may be implemented as, for example, a local area network that provides a medium used to provide communication links between various devices and computers connected together within network system 100. Network device interconnections may be implemented as wireline or wireless links. Of course, network system 100 also may be implemented as any number of different types of networks, such as, for example, an intranet, a wide area network (WAN), or any other suitable network configuration. FIG. 1 is intended as an example, and not as an architectural limitation, of a network system in which embodiments described herein may be implemented.

In the depicted example, system 100 includes a change administrator server 102 from which entitlements are delegated by a primary administrator. Pursuant to providing conditional entitlements, change administrator server 102 may include or interface with a change administrator database 104. Change administrator database 104 maintains a table or other data structure that stores entitlements that may include an operator identifier, a network entity, an optional operational privilege, and a schedule. Change administrator database 104 is the repository of configuration and state data for change administrator server 102.

In the present example, system 100 includes two managed servers, an application server 106 and a file server 108, on which operational privileges may be granted to operators in accordance with conditional privilege delegations defined by entitlements maintained in database 104 and with which an operator may engage in a remote session consistent with the conditional privileges allocated to the operator. In the present example, servers 106 and 108 each have a respective identifier or name of Server_A and Server_B assigned thereto. System 100 may include an administrator console 110 from which the primary administrator delegates entitlements to operators that may access system entities or nodes via one or more operator consoles 112. Operator console 112 is used by an operator to request access to a server and one or more tools, e.g., management or administrative applications, for use on the selected server.

An operator console server 114 may be configured to communicatively couple with operator console 112 and database 104. Operator console server 114 may be configured to receive access requests from operator console 112 and evaluate records in database 104 to determine whether to grant or deny the access request. Operator console server 114 may provide a menu or other user-selectable options to an operator at operator console 112 in response to operator console 112 connecting with console server 114. For example, operator console server 114 may generate and transmit a web page including a menu of servers and/or applications to which the operator is granted access. In one implementation, operator console server 114 obtains an identification of an operator, such as a user name, when operator console 112 connects with operator console server 114. Operator console server 114 may then interrogate database 104 to identify any network entities, and operator privileges associated therewith, to which the operator is currently permitted access.

While operator console server 114 is depicted as a distinct entity within system 100, operator console server 114 may be integrated with, for example, change administrator server 102. Network system 100 may include various other entities, such as a reporting services console 116 that interfaces with database 104. Reporting services console 116 may be configured to perform auditing services on granted access permissions, access denials, access violations, and the like. Additionally, system 100 may include an authentication directory 118, such as Active Directory™ manufactured by Microsoft Corporation, of Redmond, Wash., that maintains or defines user and/or group accounts, configured in accordance with entitlements maintained in database 104. In a particular embodiment, authentication directory 118 may comprise a hierarchical directory service comprising objects of particular object classes including user and group object classes. Operator objects may be dynamically added and removed from authentication directory 118 to provide for dynamic account enablement that allows for granting access requests on demand from operators in accordance with pre-defined conditional entitlements. The dynamically enabled accounts may be enabled contingent on an access request conforming to an entitlement, and are thus enabled just in time to satisfy the access request.

Administrator console 110 may be implemented as, for example, a Win32 application running on a network client adapted to configure and manage change administrator server 102. Administrator console 110 preferably provides various functions for creating and managing entitlements that are stored in database 104. Additionally, administrator console 110 may be adapted to configure launchable applications and may group launchable applications into toolkits that may be presented to an operator console. Various other functions may be provided by administrator console 110 that generally facilitate efficient management of system 100, such as displaying a summary of the current system status, adjustment of metadata fields, import and export of tools, toolkits, and entitlements that have been defined, or other suitable administrative functions.

Responsibilities of change administrator server 102 may include delegation, or set up, of entitlements, managing user and group accounts, monitoring operator sessions, auditing configuration and entitlement changes, sending selected event notifications by email, managing database 104, and manipulating and managing authentication directory 118. Change administrator server 102 may also publish various performance counters.

Change administrator server 102 may allocate entitlements for other administrators of any varying administrative capacity. In accordance with embodiments described herein, an operator having privileges delegated thereto by a primary administrator is not able to change the administrative configuration of change administrator server 102 and may not modify or set entitlements delegated thereto. Change administrator server 102 may be configured to report various events, including, for example, configuration changes, entitlement grants, license issues, etc., to an event log or entity, such as reporting services console 116.

In accordance with an embodiment, granting and revoking permissions to an operator may be made based on an entitlement schedule thereby reducing errors while maintaining tight privilege controls. As described herein, a system administrator can specify when to grant, deny, and revoke permissions, and the conditional permissions are automatically enforced based on time-based permission policies. Particularly, a user account may be dynamically created, enabled, and disabled in authentication directory 118 for an operator in accordance with conditional privileges defined in change administrator database 104 in response to an access request being issued by the operator, and accounts dynamically created, enabled, and/or disabled in such a manner are referred to herein as proxy accounts. Advantageously, the system administrator can control permissions while not having to remember or manually provide a permission allowance or revocation at a particular time. This mechanism may provide substantial savings in both time and money, reduce errors, and improve access controls.

In one embodiment, times may be presented in GMT or Universal Time to facilitate accommodation of servers in different time zones. For time-limited permissions, the time granularity may be, for example, implemented in half-hour increments, minute increments, or another suitable interval. If a user successfully obtains authorized access to a server in accordance with a conditional permission but doesn't log off the server prior to expiration of an end time of the conditional permission's time based policy, an event noting the policy violation may be generated. Preferably, the user is not forcibly logged out but instead may be notified of the time-based policy violation. However, in other embodiments, the user may be forcibly logged off of the server, e.g., by disablement of a proxy account through which the operator has been provided access to a system resource, such as managed servers 106 and 108.

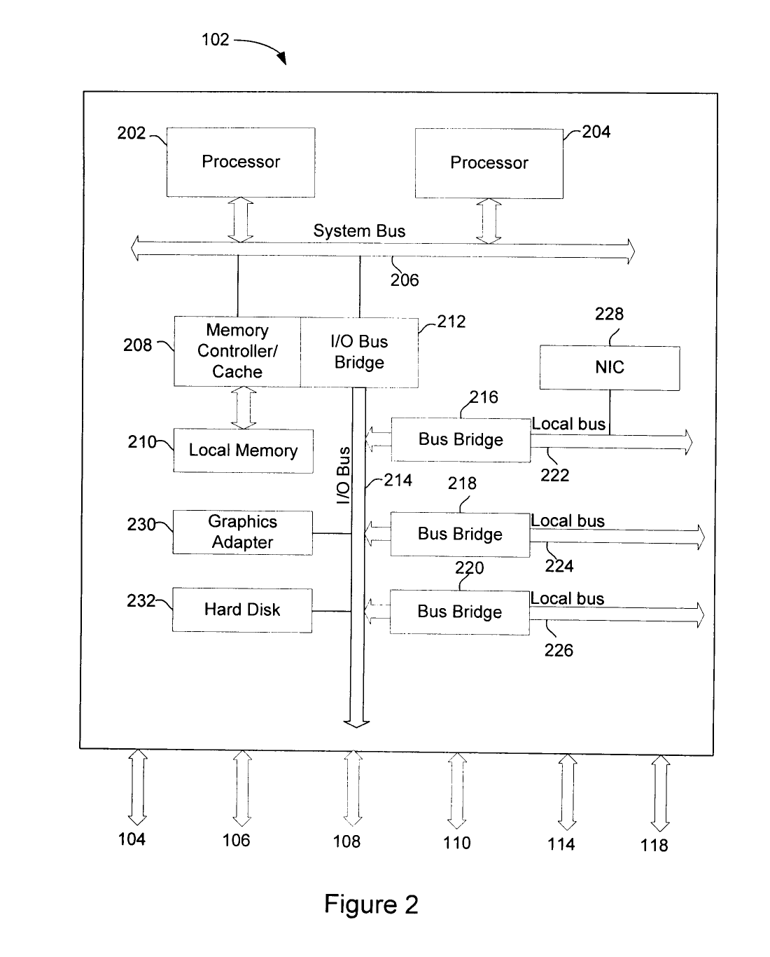

FIG. 2 is a diagrammatic representation of an exemplary change administrator server 102 that may be configured for delegation of conditional time-based permissions and permission authorizations in accordance with embodiments disclosed herein.

Server 102 may be a symmetric multiprocessor (SMP) system that includes a plurality of processors 202 and 204 connected to a system bus 206 although other single-processor or multi-processor configurations may be suitably substituted therefor. A memory controller/cache 208 that provides an interface to local memory 210 may also be connected with system bus 206. An I/O bus bridge 212 may connect with system bus 206 and provide an interface to an I/O bus 214. Memory controller/cache 208 and I/O bus bridge 212 may be integrated into a common component.

A bus bridge 216, such as a Peripheral Component Interconnect (PCI) bus bridge, may connect with I/O bus 214 and provide an interface to a local bus 222, such as a PCI local bus. Communication links to other network nodes of system 100 in FIG. 1 may be provided through a network interface card (NIC) 228 connected to local bus 222 through add-in connectors. Additional bus bridges 218 and 220 may provide interfaces for additional local buses 224 and 226 from which peripheral or expansion devices may be supported. A graphics adapter 230 and hard disk 232 may also be connected to I/O bus 214 as depicted.

Those of ordinary skill in the art will appreciate that the hardware depicted in FIG. 2 may vary. The depicted example is not intended to imply architectural limitations with respect to implementations of the present disclosure. Managed servers, such as application server 106 and file server 108, may be implemented similar to change administrator server 102 depicted in FIG. 2, although any variety of hardware configurations may be used for implementing servers 106 and 108.

In accordance with embodiments disclosed herein, a primary administrator may log onto or otherwise access server 102. An entitlement delegation application implemented as computer-executable instructions maintained or accessed by server 102 may be executed, and a user interface may then be provided to the primary administrator, e.g., at administrator console 110. For example, server 102 may generate a web page or other data structure that is conveyed to administrator console 110 and that provides for prompts or other data input items for configuration of conditional entitlements.

Embodiments disclosed herein may be implemented as computer-executable instructions tangibly embodied on a computer-readable medium, such as local memory 210 or hard disk 232, that are run in conjunction with an operating system, such as a Unix operating system implemented as computer executable instructions executed by an instruction execution device, such as one or more of processors 202 and 204.

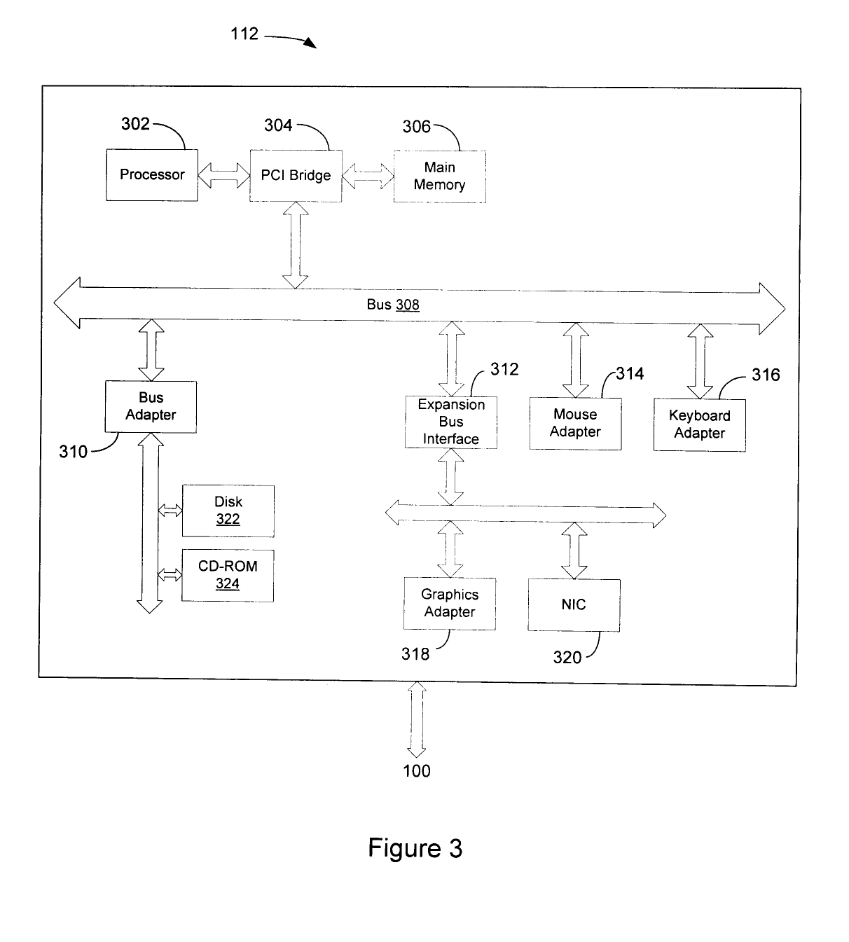

FIG. 3 is a diagrammatic representation of an exemplary embodiment of operator console 112 depicted in FIG. 1.

Code or instructions implementing operator console processes of embodiments disclosed herein may be located or accessed by console 112. In the illustrative example, console 112 employs a PCI local bus architecture, although other bus architectures, such as the Industry Standard Architecture (ISA), may be used. A processor system 302 and a main memory 306 are connected to a PCI local bus 308 through a PCI bridge 304. PCI bridge 304 also may include an integrated memory controller and cache memory for processor system 302. Additional connections to PCI local bus 308 may be made through direct component interconnection or through add-in connectors. In the depicted example, a small computer system interface (SCSI) host bus adapter 310, an expansion bus interface 312, a mouse adapter 314, and a keyboard adapter 316 are connected to PCI local bus 308 by direct component connection. In contrast, a graphics adapter 318 and a NIC 320 are connected to PCI local bus 308 via expansion bus interface 312 by add-in boards inserted into expansion slots. NIC 320 provides an interface for connecting console 112 with other devices in system 100 depicted in FIG. 1. Expansion bus interface 312 provides a connection for various peripheral devices. SCSI host bus adapter 310 provides a connection for a hard disk drive 322, and a CD-ROM drive 324. Typical PCI local bus implementations may support a plurality of PCI expansion slots or add-in connectors.

An operating system runs on processor system 302 and is used to coordinate and provide control of various components within console 112. Instructions for the operating system and applications or programs are located on storage devices, such as hard disk drive 322, and may be loaded into main memory 306 for execution by processor system 302.

In accordance with embodiments disclosed herein, an operator may submit a request for access to a network entity, such as application sever 106, file server 108, or another network node, by initiating a communication connection with operator console server 114. To this end, operator console 112 may be configured as a client of operator console server 114. Communication connections between operator console 112 and operator console server 114 may be made on the TCP/IP protocol suite, although other communication protocols may be suitably substituted therefor. Implementations of disclosed embodiments are not limited to any particular protocol and those described are provided only to facilitate an understanding of the embodiments.

In one embodiment, operator console 112 may be configured to convey an explicit access request to operator console server 114. In another embodiment, operator console 112 may be configured to convey a generic access request to operator console server 114. As referred to herein, an explicit access request comprises a request that specifies a particular network entity to which the operator desires access. As referred to herein, a generic access request does not include a specification of a particular network entity to which the operator desires access.

An explicit access request may include a request parameter that defines a particular network entity to which the operator seeks access. For example, operator console 112 may be configured with a client application that presents a user interface to the operator that includes a menu of server names for which the operator has entitlements configured therefor. For example, assume a particular operator has entitlements configured in database 104 that grant some form of access rights to both application server 106 and file server 108. In this instance, change administrator server 102 or another suitable entity may convey a client application, or data for display thereby, to operator console 112 that is adapted to display a menu including names of application server 106 and file server 108. Operator console 112 may connect with operator console server 114 in response to selection of one of the server names by the operator, and the operator console 112 may transmit an identity of the selected server and an identity of the operator in an explicit access request message to operator console server 114. Operator console sever 114, in response to receipt of the explicit access request, may interrogate change administrator database 104 with an identity of the operator and an identity of the selected server to which the operator seeks access. For example, operator console server 114 may formulate an SQL SELECT operation to retrieve records from database 104 that include the specified operator and server. On receipt of a record set from database 104, operator console server 114 may then evaluate the records to determine whether the operator currently has access rights to the selected server. Operator console server 114 may then generate a web page or other data structure that indicates the access rights, if any, currently available to the operator. Additionally, change administrator server 102 may configure, e.g., create or enable, a proxy account assigned to the operator that is used to enforce the current access permissions of the operator. Change administrator sever 102 may add the account assigned to the operator to authentication directory 118 or a user group thereof, and may add the operator to a user group maintained, or otherwise interfaced, by the particular server to which the operator is to engage in a remote session. The operator may then access the server via a remote session.

A generic access request may exclude any identification of a particular network entity to which the operator seeks access and instead may simply indicate the operator wishes to be notified of what access permissions the operator may currently exercise. For example, operator console 112 may be configured with a client application that generates a generic access request, connects with operator console server 114, and transmits the generic access request thereto. The generic access request may, for example, include an identifier of the operator desiring access in network system 100. Operator console sever 114, in response to receipt of the generic access request, may interrogate change administrator database 104 with an identity of the operator. For example, operator console server 114 may formulate an SQL SELECT operation to retrieve records from database 104 that include the specified operator. On receipt of a record set from database 104, operator console server 114 may then evaluate the records to determine whether the operator currently has access rights to any servers or other entities in network system 100. Operator console server 114 may then generate a web page or other data structure that indicates the access rights, if any, currently available to the operator and transmit the web page to operator console 112. Additionally, change administrator server 102 may configure a proxy account assigned to the operator that is used to enforce the current access permissions of the operator. Change administrator sever 102 may add the proxy account assigned to the operator to authentication directory 118, or a user group thereof, and may add the operator to a user group maintained by the particular server to which the operator is to engage in a remote session. The operator may then access the server, if any, identified as currently accessible by the operator via a remote session therewith. In this manner, operator console 112 is notified of all available access rights currently allowed and may make a network entity selection accordingly.

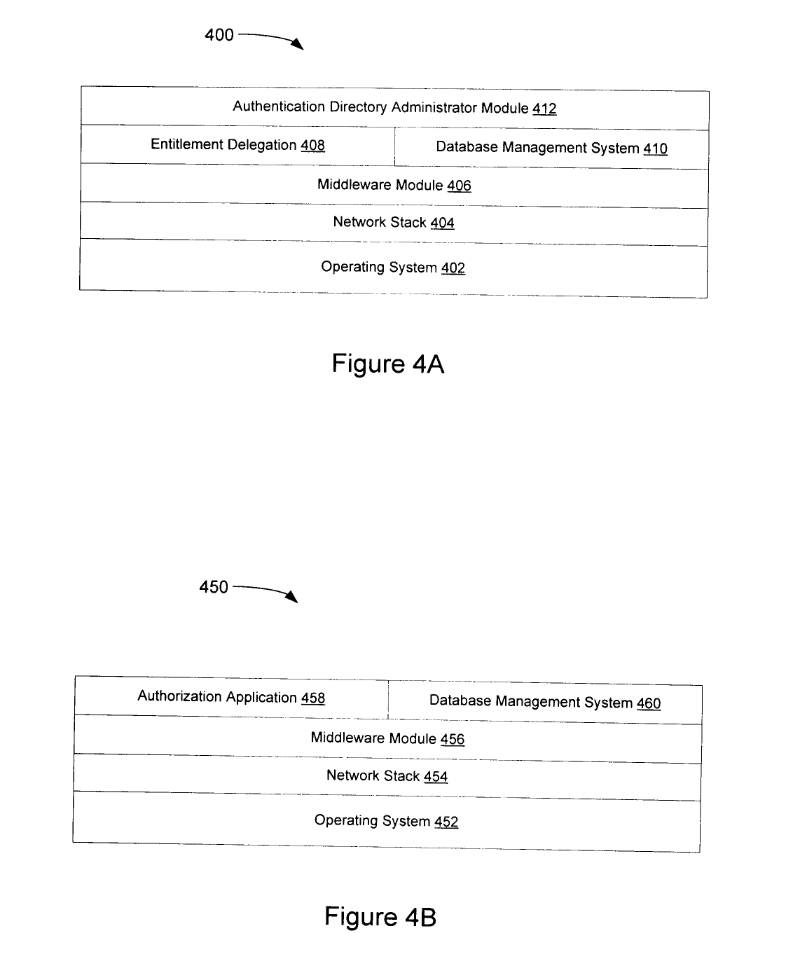

FIG. 4A is a diagrammatic representation of an embodiment of a software configuration 400 of change administrator server 102 depicted in FIGS. 1 and 2 that facilitates conditional entitlement configuration and enforcement in accordance with embodiments disclosed herein. Configuration 400 includes an operating system 402 that manages execution of a network stack 404 that provides for network communications. For example, network stack 404 may be implemented as a transmission control protocol/Internet protocol (TCP/IP) stack. A middleware module 406, such as Websphere Application Server(™) manufactured by International Business Machines or the like, may be deployed and run on network stack 404 that facilitates set up and operation of an entitlement delegation module 408. Entitlement delegation module 408 includes logic for receiving entitlement parameters, e.g., conditional access configuration parameters, from administrator console 110 and may interface with a database management system 410 adapted to query and manipulate change administrator database 104. For example, database management system 410 may comprise SQL parser and optimizer routines or instruction sets adapted for interfacing with the particular implementation of change administrator database 104. In the illustrative configuration, delegation module 408 may receive entitlement parameters and formulate SQL operations that are conveyed to database management system 410 that, in turn, executes the operations on change administrator database 104. Database management system 410 may receive result sets from change administrator database 104 and convey the results to entitlement delegation module 408 for evaluation or other processing.

Configuration 400 may also include an authentication directory administrator module 412 adapted to interact with authentication directory 118 depicted in FIG. 1. Authentication directory administrator module 412 may be implemented as a service bundled with operating system 402. Administrator module 412 may include functions for traversing authentication directory 118, adding and deleting objects to and from authentication directory 118, functions for reading values from, and writing values to, objects in authentication directory 118, or other functions for manipulating the contents of authentication directory 118.

FIG. 4B is a diagrammatic representation of an embodiment of a software configuration 450 of operator console server 114 depicted in FIG. 1 that facilitates receipt, processing, and authorization of operator access requests. Software configuration 450 includes an operating system 452 that manages execution of a network stack 454 that provides for network communications. A middleware module 456 may be deployed and run on network stack 454 that facilitates set up and operation of an authorization application 458. Authorization application 458 includes logic for receiving operator access requests from operator console 112, evaluating the access requests, and returning access request results to operator console 112. To this end, authorization application 458 may interface with a database management system 460 adapted to interface and interrogate change administrator database 104. For example, authorization application 458 may receive an access request from an operator console, formulate an SQL operator therefrom, and submit the SQL operator to database management system 460. Database management system 460 may then process and execute the SQL operation on, for example, change administrator database 104, receive a result set therefrom, and convey the result set to authorization application 458 for evaluation or other processing. Authorization application 458 may then evaluate the result set and determine whether to grant or deny access to the operator, and a suitable notification may be generated and conveyed to the operator accordingly. In other implementations, administrator server 102 may be involved in the request authorization in conjunction with, or in lieu of, operator console server 114

FIGS. 1-4B are intended as examples, and not as architectural limitations, of system, computer, and software configurations in which embodiments disclosed herein may be implemented. The particular system, computer architectures, and software configurations shown and described are illustrative and are chosen only to facilitate an understanding of the disclosed embodiments.

A primary administrator may provide user or operator identifiers to change administrator server 102 for which one or more entitlements are to be delegated. The primary administrator may specify names or other identifiers of managed network servers for which an operator is to be delegated operational privileges by execution of an entitlement delegation application or routine, and may specify a list of one or more applications that may be executed on the specified server. The entitlement delegation routine may record any applications selected for authorized use by the operator on the specified network server and may receive schedule parameters for the entitlement that define a schedule for which the operator may obtain authorized access to the specified server. The entitlement may then be recorded, e.g., stored in database 104. The schedule may include, for example, a maximum number of recurrences for which the operator is to be granted access to the particular server, a recurrence pattern, such as a daily, weekly, monthly, yearly, or other suitable recurrence interval, an access start time, and an access end time. The access start time may define a start time, e.g., a time of day, at which the entitlement is to become active. In a similar manner, the access end time may define an end time at which the entitlement is to become inactive. In another embodiment, a duration value, rather than an end time, may be specified such that the entitlement is activated on authorized days at the start time for a duration specified by the duration value. The period between the start and end times on authorized days comprises an active interval during which the operator is authorized to access the network entity associated with the entitlement. Additionally, a recurrence date range may be specified that identifies a date prior to which the entitlement is not to be activated. Likewise, an end date may be specified after which the entitlement is not to be activated.

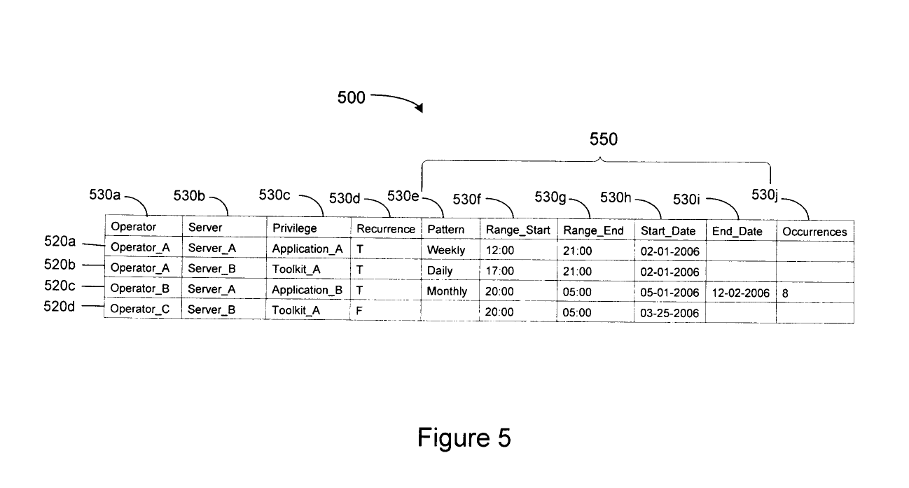

FIG. 5 depicts a diagrammatic representation of a table 500 comprising a plurality of records 520a-520d (collectively referred to as records 520) and fields 530a-530j (collectively referred to as fields 530) in which entitlements implemented in accordance with embodiments disclosed herein may be maintained. Table 500 may be stored on a disk drive or other suitable medium, fetched therefrom by a processor or other instruction processing device, and processed by a data processing system such as change administrator server 102 or operator console server 114 depicted in FIG. 1.

Fields 530 have a respective label, or identifier, that facilitates insertion, deletion, querying, or other data operations or manipulations of table 500. In the illustrative example, fields 530a-530j have respective labels of Operator, Server, Privilege, Recurrence, Pattern, Range_Start, Range_End, Start_Date, End_Date, and Occurrences. Each record 520a-520d defines an entitlement by association of various data element values recorded in fields 530a-530j, or a portion thereof, of a particular record.

In the illustrative example, data elements stored in Operator field 530a comprise operator names or other operator identifiers of operators for which entitlements are delegated in accordance with embodiments disclosed herein. Server field 530b may maintain data elements, such as server names, addresses, or other suitable identifiers, that identify network servers for which operational permissions are delegated for the corresponding entitlement or record. Privilege field 530c may maintain data elements that identify applications, operations, and/or other operational permissions that may be performed on a server identified in field 530b of an associated record. Recurrence field 530d may maintain a value that indicates whether the entitlement is of a recurrence type. For example, recurrence field 530d may have a Boolean value that, if asserted, indicates the entitlement is recurring. Pattern field 530e may store values that indicate the recurrence type, if any. For example, pattern field 530e may have a value that indicates a recurrence interval, e.g., hourly, daily, weekly, or another suitable time frame, of the entitlement recurrence. In the event that the entitlement is not configured for recurrence, pattern field 530e may be nulled. Range start and range end fields 530e and 530f may respectively store a value that indicates a start time at which the entitlement is valid and an end time at which the entitlement is invalid. Start date and end date fields 530h-530i respectively store data elements that specify a beginning date at which the entitlement may be valid and an end date, if any, at which date the entitlement expires. End date field 530i may be nulled if the entitlement is delegated indefinitely. Occurrences field 530j may store a value that defines a maximum number of occurrences that the entitlement may be valid if the entitlement is configured with an occurrence allowance. Occurrence field 530j may be nulled if no maximum number of occurrences is configured for the entitlement. Fields 530e-530i, or a portion thereof, collectively define a respective time-based schedule 550 for each of records 520a-520d.

In the present example, records 520a-520b each comprise entitlements delegated for an operator with an operator identifier (ID) of Operator_A, and records 520c-520d comprise an entitlement for a respective operator with an identifier of Operator_B and Operator_C as indicated by operator field 530a. Operator_A has conditional privileges for access to both Server_A and Server_B, each shown in FIG. 1, indicated by field 530b of entitlement records 520a-520b. Privilege field 530c restricts the access privilege of Operator_A to a single application designated Application_A on Server_A and to a set of applications designated Toolkit_A on Server_B. As referred to herein, a Toolkit comprises a set of one or more applications. For example, Toolkit_A may comprise a set of applications including applications designated Application_A and Application_B. A Boolean value of true, designated T, in field 530d specifies the entitlements defined by records 520a-520b are both recurring, and field 530e indicates the recurrence pattern of the entitlements defined by records 520a-520b are implemented on a respective weekly and daily interval. The range start and range end values of respective fields 530f and 530g indicate the access permission defined by record 520a is to be active beginning at a time of 12:00 through a time of 21:00. In a similar manner, the range start and range end values of respective fields 530f and 530g indicate the access permission defined by record 520b is to be active beginning at a time of 17:00 through a time of 21:00. The times specified by fields 530f-530g may be interpreted as GMT, another global time, or a local time. Field 530h specifies that both entitlements defined by records 520a-520b are set to activate on a date of Feb. 1, 2006. Field 530i of records 520a-520b is nulled thereby indicating that the entitlements defined by records 520a-520b are delegated indefinitely. That is, the entitlements defined by records 520a-520b do not have a defined date for expiration. Field 530j is nulled for both of records 520a-520b thereby indicating that the entitlements defined by records 520a-520b are not subject to a maximum occurrence limit.

Another operator with an operator ID of Operator_B has an entitlement that defines a conditional access permission to Server_A as indicated by fields 530a and 530b of record 520c. Field 530c of record 520c indicates Operator_B has an access privilege to Application_B. The entitlement defined by record 520c provides an access permission that recurs monthly as indicated by fields 530d and 530e. The range start and range end values of respective fields 530f and 530g indicate the access permission defined by record 520c is to be active beginning at a time of 20:00 through a time of 05:00. Fields 530h and 530i indicate the entitlement defined by record 520c is activated on May 1, 2006 and is set to expire on Dec. 2, 2006. Field 530j specifies that the entitlement defined by record 520d has a maximum occurrences value of 8.

Another operator with an operator ID of Operator_C has an entitlement that defines a conditional access permission to Server_B as indicated by fields 530a and 530b of record 520d. Field 530c of record 520c indicates Operator_C has an access privilege to a toolkit or application set designated Toolkit_A. The entitlement defined by record 520d provides a non-recurring access permission as indicated by field 530d, and thus no recurrence pattern is specified in field 530e. The range start and range end values of respective fields 530f and 530g indicate the access permission defined by record 520d is to be active beginning at a time of 20:00 through a time of 05:00. Field 530h indicates the entitlement defined by record 520d is activated on Mar. 25, 2006. Because the entitlement is non-recurring, no end date of the entitlement or number of occurrences are specified by fields 530i and 530j. Alternatively, an occurrence value of 1 may be specified in field 530j.

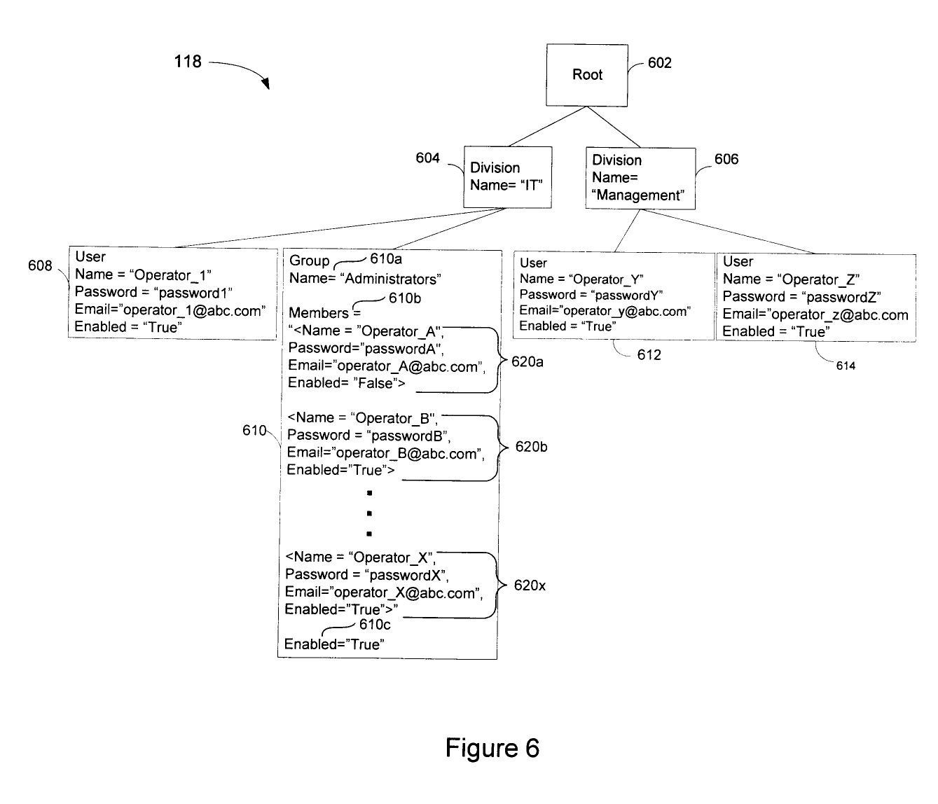

FIG. 6 is a diagrammatic illustration of authentication directory 118 in which proxy accounts may be created, enabled, and disabled according to conditional entitlements defined in table 500 depicted in FIG. 5 in accordance with embodiments disclosed herein.

Authentication directory 118 may comprise a hierarchical directory service including a tree of objects. Objects of authentication directory 118 may define user accounts or user account groups that may be created or enabled in response to an operator request for access to a network entity, such as a managed server deployed in network system 100. A user account dynamically created or enabled in authentication directory 118 in response to a user or operator request for access to a network entity may be created or enabled consistent with conditional privileges defined in table 500. A dynamic user or group account that is created or enabled in response to a user request and consistent with a conditional privilege is referred to herein as a proxy account. The proxy account may be used for allowing a remote operator session with the network entity specified in the conditional privilege.

Authentication directory 118 may include a root object 602 and any number of child objects 604 and 606. Objects in authentication directory 118 may comprise objects of a particular class and may include properties of the particular object. For example, object 604 and 606 may represent a corporate facility or division. In the illustrative example, objects 604 and 606 are objects of a class Division and have a property Name of IT and Management, respectively. User objects may define user accounts, or characteristics thereof. For example, a user object 608 is configured as a child node of object 604 and includes properties of Name, Password, Email, and Enabled. The user object property Name defines the operator's name illustratively designated as Operator_1 in the present example, and may comprise, for example, an operator's legal name, a network login name, or other operator identifier. The user object property Password has a value of password1 that may define the operator's network login password. The user object property Email may store the operator's email address. The user object property Enabled may have a Boolean value that specifies whether the user account is currently enabled or disabled. In the present example, the user account defined by user object 608 has an Enabled property value of True and thus is representative of an enabled user account.

Additionally, a Group object 610 may define groups of user accounts, or characteristics thereof. For example, group object 610 is configured as a child node of object 604 and includes a Group Name property 610a, a Members property 610b, and an Enabled property 610c. In the illustrative example, the Group Name property has a value Administrators, and the Members property includes a delimited list of member or user property sets that respectively define user accounts. For example, a first user account 620a is defined by a delimited property set that includes member properties of Name, Password, Email, and Enabled each assigned values of Operator_A, passwordA, operator_A@abc.com, and False, thereby indicating the user account defined by the associated property set is currently disabled. In a similar manner, other user accounts 620b-620×for Operator_B-Operator_X are defined by respective property sets. Enabled property 610c of group object 610 is set to a value of True thereby indicating that group object 610 is enabled. Each user account defined by group object 610 may be disabled by setting Enabled property 610c of object 610 to False. Other user accounts may be similarly included in authentication directory 118, such as user accounts defined by objects 612 and 614. Because authentication directory 118 is hierarchically configured, each object 602-614 may be uniquely identified by a path from the root to the object. For example, group object 610 is uniquely identified by the path Division=IT/Group=Administrators.

In accordance with embodiments, user accounts may be created or enabled in authentication directory 118 consistent with the conditional privileges defined in database 104. For example, assume Operator_A accesses network system 100 via operator console 112 and issues a request for access to Server_A in accordance with the privilege, recurrence, and schedule time defined in the entitlement specified by record 520a depicted in FIG. 5. On confirmation that the operator has an entitlement for access to Server_A and that the request is made within the active period of the entitlement, user account 620a assigned to Operator_A may be enabled in authentication directory 118 for the operator. In the event that an account is not defined for the operator in authentication directory 118, one may be created and enabled. Once the user account is enabled, a remote session may be established between operator console 112 and server 106. To this end, the user may be added to a user group 120 maintained by server 106 to which the operator has requested access. Thus, the user account is created and/or enabled dynamically in response to an access request by the user and in accordance with conditional entitlements specified in database 104.

FIG. 6 is intended as an example, and not as an architectural limitation, of an authentication directory that may facilitate implementation of various embodiments disclosed herein, and other data structures, such as a relational database, may suitably be substituted therefor.

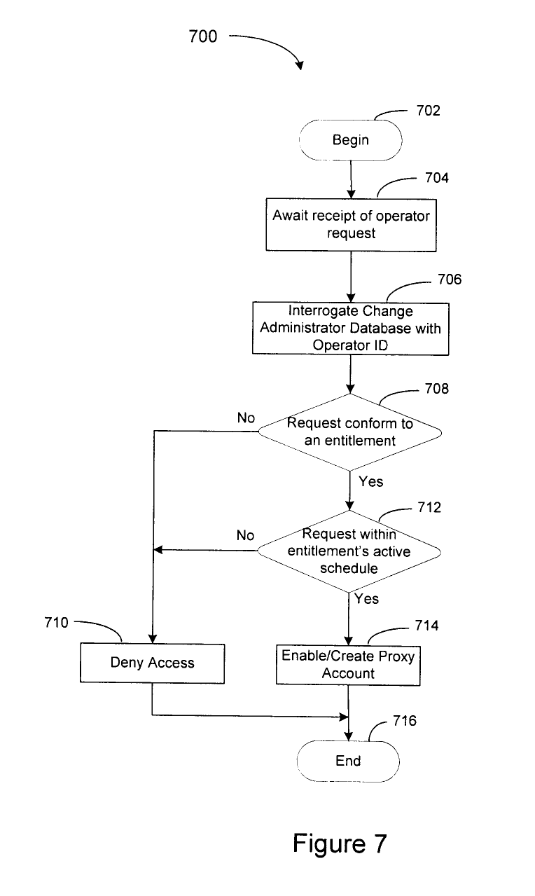

FIG. 7 is a flowchart 700 depicting processing steps of an authorization routine for authorizing operator requests in accordance with embodiments disclosed herein. At step 702, the authorization routine is invoked. On receipt of an access request, at step 704, the authorization routine may proceed to interrogate change administrator database 104 to facilitate evaluation of the request according to step 706. For example, the authorization routine may interrogate change administrator database 104 with an operator identifier. Additionally, other parameters may be used for interrogating change administrator database 104. In one implementation, the authorization routine may interrogate change administrator database 104 with an identifier of the server on which the operator has requested permission to perform one or more operations. In still another embodiment, the authorization routine may include an identifier of a specific application or operation the operator wishes to perform on a particular server. Other implementations for interrogating change administrator database 104 may be suitably implemented, and those described are chosen only to facilitate an understanding of embodiments disclosed herein.

At step 708, an evaluation may then be made to determine if the access request conforms to an entitlement. For example, table 500 may be interrogated to determine if the operator has any entitlement for the particular server on which the operator has requested access. In the event that the request does not conform to an entitlement, the authorization routine may proceed to deny the access request according to step 710. At step 716, the authorization routine cycle may then end.

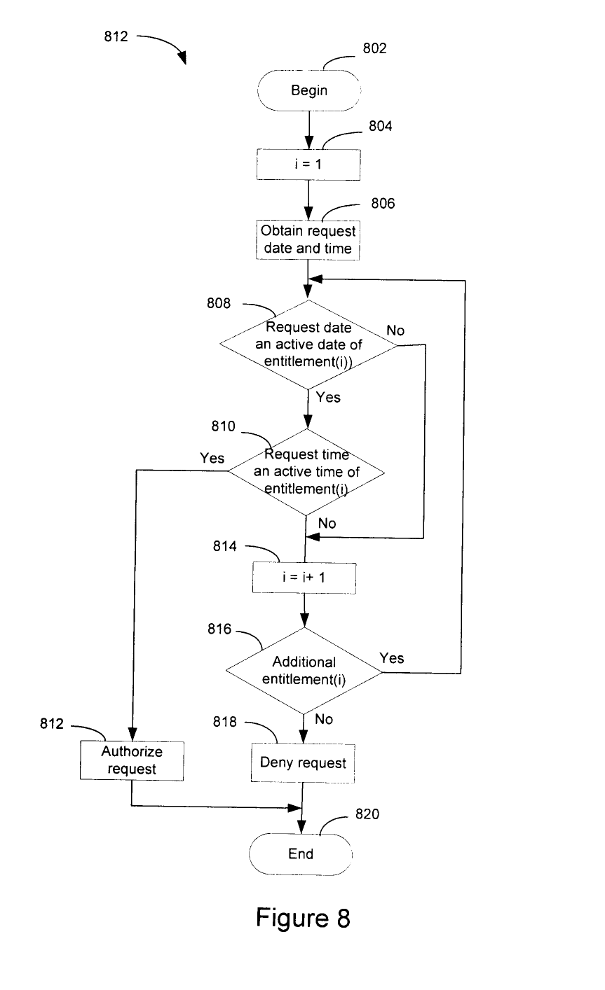

Returning again to step 708, in the event that the access request conforms to an entitlement, an evaluation may then be made to determine if the access request is within the active schedule of the entitlement according to step 712 and as described more fully hereinbelow with reference to FIG. 8. In the event that the access request is not within the active schedule, the authorization routine may deny access to the operator according to step 710. The authorization routine may proceed to grant access if the access request is made within the active schedule of the entitlement by creating or enabling a proxy account in authentication database 118 according to step 714 and as described more fully hereinbelow, and the authorization routine cycle may then end according to step 716.

FIG. 8 is a flowchart of schedule evaluation step 712 depicted in FIG. 7 of a schedule evaluation subroutine for evaluating an entitlement schedule in accordance with embodiments of the disclosure.

At step 802, the schedule evaluation subroutine is invoked, and an index i may be initialized to facilitate evaluation of one or more entitlements identified as conforming to the access request at step 804. The schedule evaluation subroutine may then obtain the access request date and time at step 806, and proceed to evaluate whether the access request date is an active date of the currently evaluated entitlement(i) at step 808. For example, the schedule evaluation subroutine may evaluate the schedule pattern and start date from respective fields 530e and 530h and determine if the request date corresponds to an active entitlement date. Additionally, the schedule evaluation subroutine may also evaluate the schedule end date obtained from field 530i to determine if the entitlement has expired. In the event that the request date does not conform to the date schedule parameters of entitlement(i), the schedule evaluation subroutine may proceed to increment the index variable i according to step 814.

Returning again to step 808, in the event that the request date conforms to the schedule date parameters of entitlement(i), the schedule evaluation subroutine may proceed to evaluate whether the request time is an active time of entitlement(i) at step 810, i.e., conforms to the schedule time parameters of entitlement(i). For example, the schedule evaluation subroutine may evaluate the schedule start time and end time obtained from respective fields 530f and 530g for entitlement(i) being evaluated. In the event that the request time falls between the start and end times, the schedule evaluation subroutine may proceed to authorize a request compliant with entitlement(i) at step 812. Otherwise, the schedule evaluation subroutine may then proceed to increment the index variable i according to step 814.

If either the request date or time has been identified as non-conformant with entitlement(i) and the index i has been incremented, an evaluation may be made to determine whether an additional entitlement(i) remains to be evaluated against the request according to step 816. If an additional entitlement(i) remains for evaluation, the subroutine may return to step 808 to determine whether the request date is an active date of the entitlement(i). Otherwise, the schedule evaluation subroutine may then deny the access request according to step 818, and the schedule evaluation subroutine cycle may then end according to step 820.

In the event that the authorization routine determines the operator request conforms to an entitlement and is within the entitlement's active schedule, a proxy account enablement routine may be invoked. The proxy account enablement routine may be implemented as routines, functions, or other executable instructions that may be included in administrator module 412 run by change administrator server 102.

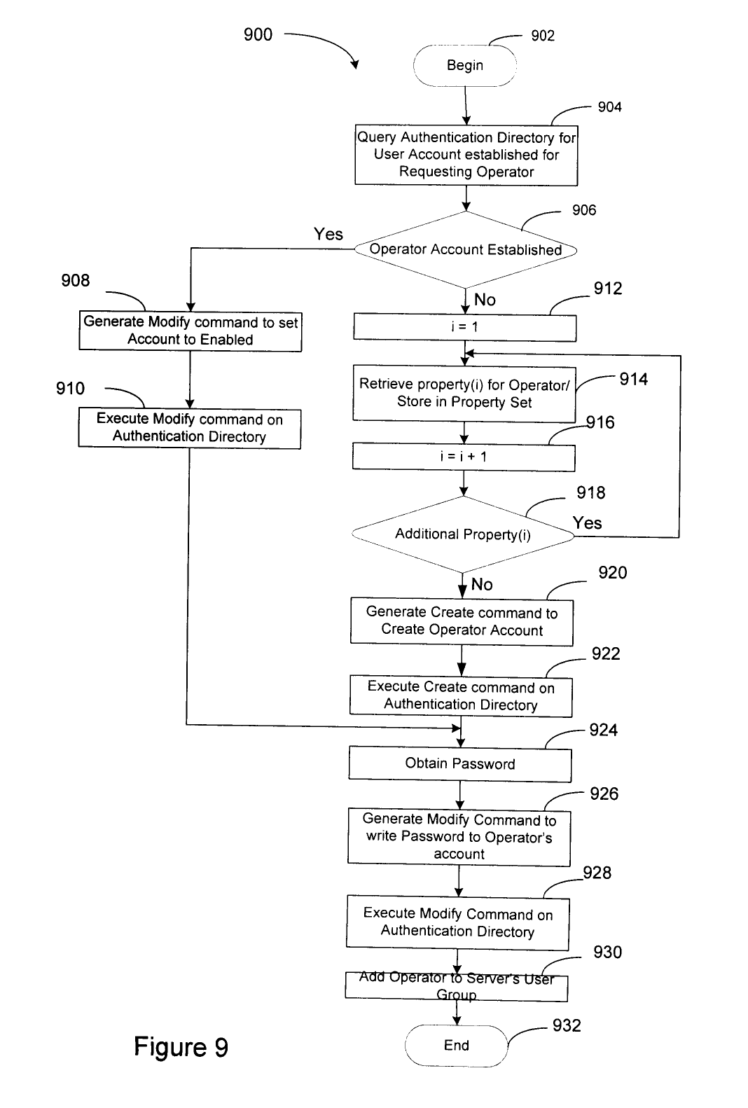

FIG. 9 is a flowchart 900 depicting an embodiment of processing steps of a proxy account enablement routine that facilitates dynamic account enablement. At step 902, the enablement routine is invoked, for example upon successful determination that an operator access request conforms to an entitlement defined in database 104 and that the access request is made within the entitlement's active schedule. The enablement routine may then query authentication directory 118 for information of a user account established for the requesting operator at step 904. An evaluation may then be made to determine if an account for the requesting operator exists in authentication directory 118 at step 906. In the event that an account exists in authentication directory 118 for the requesting operator, the enablement routine may generate, at step 908, a modify command to set the user account to enabled, and the modify command may then be executed on authentication directory at step 910. For example, execution of the modify command may set the Enabled property of the account assigned to the operator to True. The enablement routine may then obtain a password according to step 924. For example, the enablement routine may include a pseudo-random generator for generating randomized passwords.

Returning again to step 906, in the event that authentication directory 118 does not include an account for the requesting operator, the enablement routine may initialize an index i, at step 912, and may retrieve a property(i) for the operator account and temporarily store the property(i) in a property set at step 914. For example, a storage of account properties, such as operator name, email address, password, and the like, may be maintained or interfaced with change administrator server 102. Change administrator server 102 may read the properties assigned to the operator for which the user account is to be created and accumulate the properties in a property set to facilitate account creation in authentication directory 118. The index i may then be incremented at step 916, and the enablement routine may evaluate whether an additional property(i) remains to be included in the user account at step 918. In the event that an additional property(i) remains, the enablement routine may return to step 914 to retrieve the property(i).

Once a property set is accumulated for the user account, a create command may be generated, at step 920, that may include each of the user account properties accumulated in the property set. The create command may then be executed on authentication directory 118 at step 922 thereby adding a user account to the operator to authentication directory 118. An enabled property may be included in the accumulated property set that is set to a value of True so that the account created at step 922 is enabled on creation thereof.

At step 924, a password may be obtained by the enablement routine by, for example, a pseudo-random generator or other mechanism, and a modify command may then be generated to write the newly obtained password to the user account at step 926. The modify command may then be executed on the user account at step 928, and the enablement routine may add the user to a user group maintained by the server for which the operator is to be granted access at step 930. The enablement routine may then exit according to step 932. A remote session may thereafter be established between the operator console and the server to which the operator has been granted access.

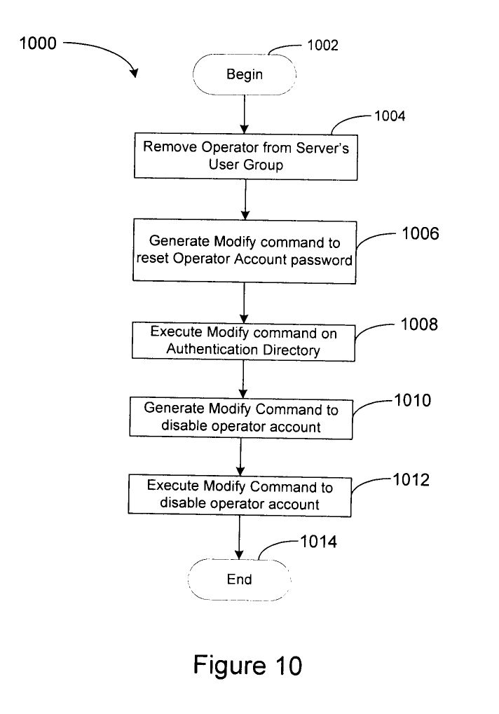

FIG. 10 is a flowchart 1000 depicting an embodiment of processing steps of a proxy account disablement routine that facilitates disablement of a dynamically enabled account. The proxy account disablement routine may be implemented as routines, functions, or other executable instructions that may be included in administrator module 412 run by change administrator server 102.

The proxy account disablement routine is invoked at step 1002, for example upon termination of a remote session between an operator and a managed server. The disablement routine may then connect with the server with which the operator has had a session therewith terminated and remove the operator from the server's user group at step 1004. A modify command is then generated, at step 1006, to change the password of the operator's account in authentication directory 118, and the modify command may then be executed on authentication directory 118 at step 1008. For example, a pseudo-randomized password may be obtained by the disablement routine. In another implementation, the modify command executed on authentication directory 118 may null or otherwise delete the operator's user account password. A modify command may then be generated to disable the operator's user account at step 1010, and the modify command may then be executed, at step 1012, on authentication directory 118 thereby disabling the operator's user account. The account disablement routine may then exit according to step 1014.

Returning again to FIGS. 1, 5, and 6, consider an operator with an operator or user identifier designated Operator_A. In accordance with embodiments described herein, Operator_A would be allowed to access server 106, i.e., Server_A depicted in FIG. 1, with operator privileges restricted to Application_A from 12:00 to 21:00 on Feb. 1, 2006. The same access privilege is available to Operator_A on a weekly basis, i.e., on Feb. 8, 2006, Feb. 13, 2006, etc. If Operator A requests access to Server A outside this recurring period, the operator's access request would be denied. In a similar manner, Operator_A may be granted access restricted to Toolkit_A on a daily basis from 17:00 to 21:00 beginning on Feb. 1, 2006.

Assume Operator_A accesses system 100 via operator console 112 and issues an access request for access to server 106 at 13:00 on Feb. 1, 2006. The access request may be conveyed from operator console 112 to operator console server 114. Operator console server 114 may, in turn, interrogate database 104 to evaluate entitlements maintained thereby. Evaluation of the entitlement defined by record 520a may result in a determination that the access request is compliant with record 520a and is was issued within the active period defined by record 520a. In this instance, operator console server 114 may convey a proxy account enablement request to change administrator server 102 on behalf of operator console 112. The enablement request may include an identifier of Operator_A. Change administrator server 102 may then interrogate authentication directory 118 for account information assigned to Operator_A. In the illustrative example, proxy account 620a is assigned to Operator_A and is currently disabled. Accordingly, change administrator server 102 may generate a modify command that includes instructions for changing the Enabled property of account 620a to a value of True. Change administrator server 102 may then execute the modify command on authentication directory 118 thereby enabling account 620a. Change administrator server 102 may then convey the operator's network username, e.g., Operator_A, to server 106, and the username may then be added to user group 120. A remote session may then be established between operator console 112 and server 106. When the remote session is terminated, change administrator server 102 may be notified, and may thereafter generate and execute another modify command the disable account 620a.

The flowcharts of FIGS. 7-10 depict process serialization to facilitate an understanding of disclosed embodiments and are not necessarily indicative of the serialization of the operations being performed. In various embodiments, the processing steps described in FIGS. 7-10 may be performed in varying order, and one or more depicted steps may be performed in parallel with other steps. Additionally, execution of some processing steps of FIGS. 7-10 may be excluded without departing from embodiments disclosed herein. The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

As described, a system, method, and computer-readable medium for dynamic enablement of user accounts in a network system are provided. An operational permission assigned to an operator may be configured to provide conditional operational access to a network entity. In one embodiment, conditional access to the network entity is based on the time at which the operator requests access to the network entity. In other embodiments, recurring intervals during which access to the network entity may be defined. In this manner, a primary administrator may delegate operational permissions or privileges to network operators, and automated enforcement procedures determine whether an access request complies with, or violates, a time-based permission policy. A user account included in an authentication directory may be dynamically enabled in response to a determination that an access request issued by an operator is compliant with a schedule defined in an entitlement assigned to the operator. A remote session may be established between an operator console and the network entity once the user account is enabled. The user account maintained in the authentication directory may be dynamically disabled in response to termination of the remote session.

Embodiments disclosed herein provide a system, method, and computer-readable medium for enabling a user account in a network system. A request for access to a network server is received from an operator at an operator console, and the request is evaluated with a conditional entitlement including a schedule that defines an active period during which the operator has operational privileges on the network server. A user account assigned to the operator is enabled in an authentication directory in response to determining the request is authorized. In another embodiment, the user account is added to the authentication directory if a determination is made that the user account is not included in the authentication directory. Adding the user account may comprise adding a property set to a members property of a group object in the authentication directory. Enabling the user account may comprise modifying an enabled property of the user account to indicate the user account is enabled. In accordance with another embodiment, an identifier of the operator may be added to a user group managed by the network server. A remote session between the operator console and the network server may be established. In another embodiment, a password reset command may be executed on the user account by a network server. An enabled property of the user account may be modified in response to determining a remote session between the operator console and the network server has been terminated. Determining the request is authorized may comprises determining the request was issued during the active period.

In accordance with another embodiment, a computer-readable medium having computer-executable instructions for execution by a processing system, the computer-executable instructions for enabling a user account in a network system is provided. The computer-readable medium comprises instructions that receive a request for access to a network server from an operator at an operator console, instructions that evaluate the request with a conditional entitlement including a schedule that defines an active period during which the operator has operational privileges on the network server, and instructions that enable a user account assigned to the operator in an authentication directory in response to determining the request is authorized. In another embodiment, the computer-readable medium may further comprise instructions that determine the user account is not included in the authentication directory, and instructions that add the user account to the authentication directory. The instructions that add the user account may further comprise instructions that add a property set to a members property of a group object in the authentication directory. The instructions that enable the user account may further comprise instructions that modify an enabled property of the user account to indicate the user account is enabled. The computer-readable medium may further comprise instructions that add an identifier of the operator to a user group managed by the network server. The computer-readable medium may further comprise instructions that establish a remote session between the operator console and the network server. The computer-readable medium may further comprise instructions that execute a password reset command on the user account. The computer-readable medium may further comprise instructions that modify an enabled property of the user account in response to determining a remote session between the operator console and the network server has been terminated. The instructions that determine the request is authorized may comprise instructions that determine the request was issued during the active period.

In accordance with another embodiment, a system for enabling a user account in a network system is provided. The system may include an authentication directory adapted to store user accounts, a database that stores entitlements that respectively include an identifier of an operator and a schedule defining an active period during which the operator has access rights to a network entity, and a server interfaced with the authentication directory and the database. The server may be adapted to enable an account assigned to the operator in the authentication directory in response to determining an access request issued by the operator was issued during the active period. In another embodiment, the server may be adapted to create the user account in the authentication directory after determining the user account does not exist in the authentication directory. The user account may be created by adding a property set to a members property of a group object in the authentication directory, wherein the property set includes a name assigned to the operator. The server may enable the user account by modifying an enabled property of the user account to indicate the user account is enabled. The entity may comprise a managed server that includes a users group, and the server may add an identifier of the operator to the users group. The operator may access the system by an operator console, and a remote session may be established between the operator console and the network entity after the account is enabled by the server.

In accordance with another embodiment, a network system is provided that comprises means for receiving a request for access to a network server from an operator at an operator console, means for evaluating the request with a conditional entitlement including a schedule that defines an active period during which the operator has operational privileges on the network server, and means for enabling a user account assigned to the operator in an authentication directory in response to determining the request is authorized. The system may further comprise means for determining the user account is not included in the authentication directory, and means for adding the user account to the authentication directory. The means for adding the user account may comprise means for adding a property set to a members property of a group object in the authentication directory. The means for enabling the user account further comprise means for modifying an enabled property of the user account to indicate the user account is enabled. The system may further comprise means for adding an identifier of the operator to a user group managed by the network server. The system may further comprise means for establishing a remote session between the operator console and the network server. The system may further comprise means for resetting a password on the user account. The system may further comprise means for modifying an enabled property of the user account in response to determining a remote session between the operator console and the network server has been terminated. The means for determining the request is authorized may comprise means for determining the request was issued during the active period.

In accordance with another embodiment, a data structure tangibly embodied on a computer-readable medium that facilitates enabling a user account in a network system is provided. The data structure may comprise a root object, and one or more objects disposed hierarchically below the root object. A first object of the one or more objects may define a user account assigned to an operator. The user account may be enabled responsive to a determination that an access request issued by the operator is issued during an active period defined in a schedule associated with the operator. The first object may comprise an object defining a user group, and the user account may be defined by a property set included in the first object. The user account may be enabled by setting an enabled property of the property set to a value indicating the user account is enabled. The property set may be created in response to the determination. In another embodiment, the first object may be created in response to the determination.

In accordance with another embodiment, a method of enabling a user account in a network system is provided. A request for access to a network server is received from an operator at an operator console. A determination that the request was issued within an active period defined by a conditional entitlement associated with the operator is made, and an authentication directory containing user accounts is evaluated to determine if a user account associated with the operator is included in the authentication directory. An enabled property of the user account associated with the operator is modified to a value that indicates the user account is enabled, and an identifier of the operator is added to a user group of the network server. A remote session is established between the operator console and the network server.

In accordance with another embodiment, a data structure tangibly embodied on a computer-readable medium that facilitates user account enablement is provided. The data structure may comprise a root object, and one or more objects disposed hierarchically below the root object. A first object of the one or more objects may define a user account assigned to an operator. The user account may include a name property that is set to a name of the operator and an enabled property. The user account may be enabled by setting the enabled property to a value indicating the user account is enabled in response to a determination that an access request issued by the operator is issued during an active period defined in a schedule associated with the operator.

In accordance with another embodiment, a computer-readable medium having computer-executable instructions for execution by a processing system, the computer-executable instructions for enabling user accounts in a network system is provided. The computer-readable medium may include instructions that receive a request for access to a network server from an operator at an operator console, instructions that determine the request was issued within an active period defined by a conditional entitlement associated with the operator, instructions that evaluate an authentication directory containing user accounts to determine if a user account associated with the operator is included in the authentication directory, instructions that modify an enabled property of the user account associated with the operator to a value that indicates the user account is enabled, instructions that add an identifier of the operator to a user group of the network server, and instructions that establish a remote session between the operator console and the network server.

In accordance with another embodiment, a user account enablement system is provided. The system may include means for receiving a request for access to a network server from an operator at an operator console, means for determining the request was issued within an active period defined by a conditional entitlement associated with the operator, means for evaluating an authentication directory containing user accounts to determine if a user account associated with the operator is included in the authentication directory, means for modifying an enabled property of the user account associated with the operator to a value that indicates the user account is enabled, means for adding an identifier of the operator to a user group of the network server, and means for establishing a remote session between the operator console and the network server.

In accordance with another embodiment, a system for enabling user accounts in a network system is provided. The system may comprise a database that includes entitlements that define time-based privileges for respective operators, an authentication directory that has one or more objects that define user accounts, a managed network server, an operator console adapted to issue a request for access by an operator to the managed network server, and an administrator server. The administrator server may be adapted to connect with the authentication directory in response to a determination that the request is compliant with a time-based privilege of an entitlement assigned to the operator, and the administrator server may modify an enabled property of an account assigned to the operator in the authentication directory.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, network stack, or any combination thereof, executing on a single computer processor or multiple computer processors. Additionally, various steps of embodiments of the invention may provide one or more data structures generated, produced, received, or otherwise implemented on a computer-readable medium, such as a memory.

Although embodiments of the present disclosure have been described in detail, those skilled in the art should understand that they may make various changes, substitutions and alterations herein without departing from the spirit and scope of the present disclosure.

What is claimed is:

1. A method of enabling a user account in a network system, comprising:
receiving a request for access to a network server from an operator at an operator console;
evaluating the request with a conditional entitlement including a schedule that defines an active period during which the operator has operational privileges on the network server; and
enabling a user account assigned to the operator in an authentication directory in response to determining the request is authorized.

2. The method of claim 1, further comprising:
determining the user account is not included in the authentication directory; and
adding the user account to the authentication directory.

3. The method of claim 2, wherein adding the user account further comprises adding a property set to a members property of a group object in the authentication directory.

4. The method of claim 1, wherein enabling the user account further comprises modifying an enabled property of the user account to indicate the user account is enabled.

5. The method of claim 1, further comprising adding an identifier of the operator to a user group managed by the network server.

6. The method of claim 5, further comprising establishing a remote session between the operator console and the network server.

7. The method of claim 1, further comprising executing, by a network server, a password reset command on the user account.

8. The method of claim 1, further comprising modifying an enabled property of the user account in response to determining a remote session between the operator console and the network server has been terminated.

9. The method of claim 1, wherein determining the request is authorized comprises determining the request was issued during the active period.

10. A computer-readable medium having computer-executable instructions for execution by a processing system, the computer-executable instructions for enabling a user account in a network system, comprising:
instructions that receive a request for access to a network server from an operator at an operator console;
instructions that evaluate the request with a conditional entitlement including a schedule that defines an active period during which the operator has operational privileges on the network server; and
instructions that enable a user account assigned to the operator in an authentication directory in response to determining the request is authorized.

11. The computer-readable medium of claim 10, further comprising:
instructions that determine the user account is not included in the authentication directory; and
instructions that add the user account to the authentication directory.

12. The computer-readable medium of claim 11, wherein the instructions that add the user account further comprise instructions that add a property set to a members property of a group object in the authentication directory.

13. The computer-readable medium of claim 10, wherein the instructions that enable the user account further comprise instructions that modify an enabled property of the user account to indicate the user account is enabled.

14. The computer-readable medium of claim 10, further comprising instructions that add an identifier of the operator to a user group managed by the network server.

15. The computer-readable medium of claim 14, further comprising instructions that establish a remote session between the operator console and the network server.

16. The computer-readable medium of claim 10, further comprising instructions that execute, by a network server, a password reset command on the user account.

17. The computer-readable medium of claim 10, further comprising instructions that modify an enabled property of the user account in response to determining a remote session between the operator console and the network server has been terminated.

18. The computer-readable medium of claim 10, wherein the instructions that determine the request is authorized comprise instructions that determine the request was issued during the active period.

19. A system for enabling a user account in a network system, comprising:
an authentication directory adapted to store user accounts;
a database that stores an entitlement that includes an identifier of an operator and a schedule defining an active period during which the operator has access rights to a network entity;
a server interfaced with the authentication directory and the database that is adapted to enable an account assigned to the operator in the authentication directory in response to determining an access request issued by the operator was issued during the active period.

20. The system of claim 19, wherein the server is adapted to create the user account in the authentication directory after determining the user account does not exist in the authentication directory.

21. The system of claim 20, wherein the sever creates the user account by adding a property set to a members property of a group object in the authentication directory, wherein the property set includes a name assigned to the operator.

22. The system of claim 19, wherein the server enables the user account by modifying an enabled property of the user account to indicate the user account is enabled.

23. The system of claim 19, wherein the entity comprises a managed server that includes a users group, wherein the server adds an identifier of the operator to the users group.

24. The system of claim 19, wherein the operator accesses the system by an operator console, wherein a remote session is established between the operator console and the network entity after the account is enabled by the server.

25. A network system, comprising:
means for receiving a request for access to a network server from an operator at an operator console;
means for evaluating the request with a conditional entitlement including a schedule that defines an active period during which the operator has operational privileges on the network server; and
means for enabling a user account assigned to the operator in an authentication directory in response to determining the request is authorized.

26. The system of claim 25, further comprising:
means for determining the user account is not included in the authentication directory; and
means for adding the user account to the authentication directory.

27. The system of claim 26, wherein the means for adding the user account further comprise means for adding a property set to a members property of a group object in the authentication directory.

28. The system of claim 25, wherein the means for enabling the user account further comprise means for modifying an enabled property of the user account to indicate the user account is enabled.

29. The system of claim 25, further comprising means for adding an identifier of the operator to a user group managed by the network server.

30. The system of claim 29, further comprising means for establishing a remote session between the operator console and the network server.

31. The system of claim 25, further comprising means for resetting a password on the user account.

32. The system of claim 25, further comprising means for modifying an enabled property of the user account in response to determining a remote session between the operator console and the network server has been terminated.

33. The system of claim 25, wherein the means for determining the request is authorized comprises means for determining the request was issued during the active period

34. A data structure tangibly embodied on a computer-readable medium that facilitates enabling a user account in a network system, comprising:
a root object; and
one or more objects disposed hierarchically below the root object, wherein a first object of the one or more objects defines a user account assigned to an operator and wherein the user account is enabled responsive to a determination that an access request issued by the operator is issued during an active period defined in a schedule associated with the operator.

35. The data structure of claim 34, wherein the first object comprises an object defining a user group, and wherein the user account is defined by a property set included in the first object.

36. The data structure of claim 35, wherein the user account is enabled by setting an enabled property of the property set to a value indicating the user account is enabled.

37. The data structure of claim 35, wherein the property set is created in response to the determination.

38. The data structure of claim 34, wherein the first object is created in response to the determination.

39. A method of enabling a user account in a network system, comprising:
receiving a request for access to a network server from an operator at an operator console;
determining the request was issued within an active period defined by a conditional entitlement associated with the operator;
evaluating an authentication directory containing user accounts to determine if a user account associated with the operator is included in the authentication directory;
modifying an enabled property of the user account associated with the operator to a value that indicates the user account is enabled;
adding an identifier of the operator to a user group of the network server; and
establishing a remote session between the operator console and the network server.

40. A data structure tangibly embodied on a computer-readable medium that facilitates user account enablement, comprising:
a root object; and
one or more objects disposed hierarchically below the root object, wherein a first object of the one or more objects defines a user account assigned to an operator, wherein the user account includes a name property that is set to a name of the operator and an enabled property, and wherein the user account is enabled by setting the enabled property to a value indicating the user account is enabled in response to a determination that an access request issued by the operator is issued during an active period defined in a schedule associated with the operator.

41. A computer-readable medium having computer-executable instructions for execution by a processing system, the computer-executable instructions for enabling user accounts in a network system, comprising:
instructions that receive a request for access to a network server from an operator at an operator console;
instructions that determine the request was issued within an active period defined by a conditional entitlement associated with the operator;
instructions that evaluate an authentication directory containing user accounts to determine if a user account associated with the operator is included in the authentication directory;
instructions that modify an enabled property of the user account associated with the operator to a value that indicates the user account is enabled;
instructions that add an identifier of the operator to a user group of the network server; and
instructions that establish a remote session between the operator console and the network server.

42. A user account enablement system, comprising:
means for receiving a request for access to a network server from an operator at an operator console;
means for determining the request was issued within an active period defined by a conditional entitlement associated with the operator;
means for evaluating an authentication directory containing user accounts to determine if a user account associated with the operator is included in the authentication directory;
means for modifying an enabled property of the user account associated with the operator to a value that indicates the user account is enabled;
means for adding an identifier of the operator to a user group of the network server; and
means for establishing a remote session between the operator console and the network server.

43. A system for enabling user accounts in a network system, comprising:
a database that includes entitlements that define time-based privileges for respective operators;
an authentication directory that has one or more objects that define user accounts;
a managed network server;
an operator console adapted to issue a request for access by an operator to the managed network server;
an administrator server adapted to connect with the authentication directory in response to a determination that the request is compliant with a time-based privilege of an entitlement assigned to the operator and modify an enabled property of an account assigned to the operator in the authentication directory.
